(19) United States
(12) Patent Application Publication
(10) Pub. No.: US 2012/0231129 A1
(43) Pub. Date: Sep. 13, 2012

(54) FRUIT/VEGETABLE WITH ADDITIVE TO RETAIN FIRMNESS

(75) Inventors: Richard Schlomer Meyer, Kent, WA (US); Jonathan A. Merkle, Cologne, MN (US)

(73) Assignee: MICHAEL FOODS, INC., Minnetonka, MN (US)

(21) Appl. No.: 13/414,123

(22) Filed: Mar. 7, 2012

Related U.S. Application Data
(60) Provisional application No. 61/449,874, filed on Mar. 7, 2011.

(51) Int. Cl. A23B 7/157; A23L 1/216

(52) U.S. Cl. 426/321; 426/615; 426/637

(57) ABSTRACT

A firm and crisp fruit or vegetable, such as a pome or root vegetable, is at least partially infiltrated with an additive to help the fruit or vegetable retain its firmness during processing. In some examples, the additive helps the fruit or vegetable retain its firmness during and/or after cooking. In some examples, the additive includes at least one of a gluconate salt, a lactate salt, or a combination of a gluconate salt and a lactate salt. By maintaining the firmness of the fruit or vegetable during and/or after cooking, the fruit or vegetable can be cut, such as by shredding, or otherwise processed. By contrast, if the fruit or vegetable loses its firmness during processing, the fruit or vegetable may become limp or may disintegrate so that it is difficult to suitably cut or otherwise process the fruit or vegetable.

This application claims the benefit of U.S. Provisional Patent Application No. 61/449,874, filed Mar. 7, 2011, the entire contents of which are incorporated herein by reference.

### TECHNICAL FIELD

This disclosure relates to fruits and vegetables that have a firm and crisp texture and that include an additive that helps such fruits and vegetables retain firmness.

### BACKGROUND

Commercially processed foods have found widespread acceptance among the consuming public. These commercially processed foods include meats, fruits, vegetables, and nuts, to name a few example categories. The foods can be processed for a variety of different purposes. For example, the foods can be processed to increase shelf life, reduce the likelihood of bacterial growth, make the foods faster and easier to prepare by an end consumer, and even to increase the flavor and/or texture of the foods.

Commercial food processing techniques generally involve some form of washing, cutting, cooking, and/or packaging of a food. For example, consumer demands for quick and easy-to-prepare foods have led to growth in the market for precooked and precut foods. In order to prepare these types of precooked and precut foods, the foods are usually washed and then cooked in an oven, kettle, or other cooking device. Depending on the type of food being prepared, the food may be cut either prior to or after cooking.

Some commercial cooking processes change the texture of certain fruits and vegetables being cooked so that it is difficult to continue processing the food after cooking. For example, in the case of potatoes, a raw potato can turn limp and even partially disintegrate during a cooking process. This can make it difficult to subsequently cut or shred the potato to produce a precooked, precut potato product desired by many consumers.

### SUMMARY

In general, this disclosure is directed toward food items such as fruits and vegetables that have a firm and crisp texture and that include an additive that helps the food item retain firmness during and/or after cooking. Preventing a food item, such as a pome or root vegetable, from loosing too much firmness during a cooking process may be useful in that if a food item looses its firmness during cooking, the food item may become limp or may disintegrate so that it is not possible to suitably cut or otherwise continue processing the food item.

In one example according to the disclosure, a food product is described that includes a fruit or vegetable having a firm and crisp texture and that is at least partially infiltrated with an additive that functions to help retain the firmness of the fruit or vegetable upon cooking. Example firm and crisp fruits and vegetables include root vegetables (potatoes, carrots, beets, etc.), pomes from the Maloideae subfamily of the Rosaceae family (apples, pears, quince, loquat, etc.), and the like. In some examples, the additive includes a gluconate salt, a lactate salt, or a combination of the gluconate salt and the lactate salt. For example, the gluconate salt may be calcium gluconate, and the lactate salt may be calcium lactate.

In another example, a food product is described that includes a pome or root vegetable item at least partially infiltrated with an additive that includes a gluconate salt, a lactate salt, or a combination of the gluconate salt and the lactate salt. In some examples, the additive includes between 0.1 wt % and 99.9 wt % of the gluconate salt and between 99.9 wt % and 0.1 wt % of the lactate salt. In one example, the additive includes approximately 50 wt % calcium gluconate and approximately 50 wt % calcium lactate.

In another example, a method is described that includes placing a firm and crisp fruit or vegetable in a water solution that includes at least one additive that functions to help retain the firmness of such a fruit or vegetable upon cooking. In some examples, the at least one additive includes a gluconate salt, a lactate salt, or a combination of a gluconate salt and a lactate salt. In addition, in some examples, the firm and crisp fruit or vegetable is a root vegetable (such as a potato, carrot, beet, turnip) or a pome (such as an apple, pear, quince, loquat). Other firm and crisp fruits and vegetables that may benefit from the treatment with the additive include, but are not limited to, cucumbers, melons and squash.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual drawing of an example of a firm and crisp fruit or vegetable.

FIG. 2 is a flow diagram illustrating an example technique for processing a firm and crisp fruit or vegetable in a manner that helps such a fruit or vegetable retain its firmness during and/or after cooking.

### DETAILED DESCRIPTION

In general, this disclosure relates to firm and crisp fruits and vegetables that are treated with an additive to help the fruits and vegetables retain firmness during processing, e.g., including during and after cooking. In some examples, the additive helps a firm and crisp fruit or vegetable retain its firmness during and/or after cooking. By controlling the firmness of the firm and crisp fruit or vegetable during and/or after cooking, the fruit or vegetable can be cut, such as by shredding, or otherwise processed. By contrast, if the firm and crisp fruit or vegetable loses its firmness during processing, the fruit or vegetable may become limp or may disintegrate so that it is not possible to suitably cut or otherwise process the food item.

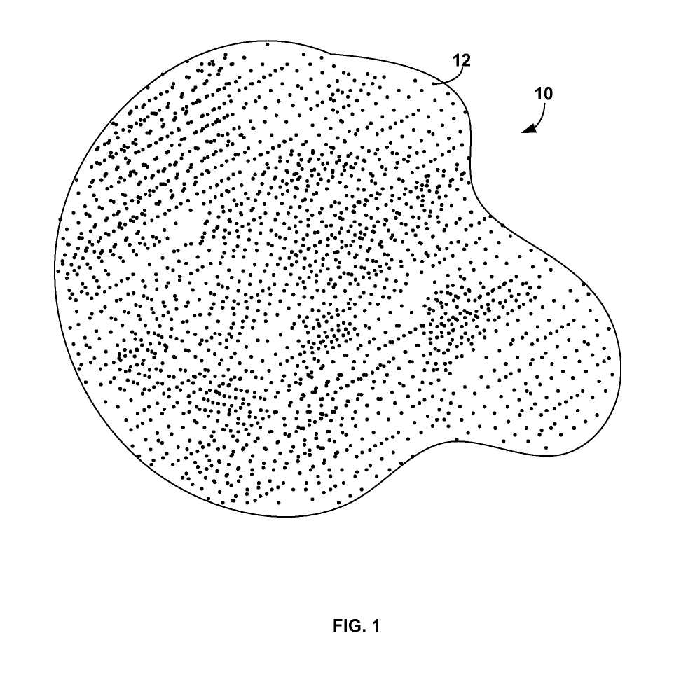

FIG. 1 is a conceptual illustration of an exemplary firm and crisp fruit or vegetable 10. By way of example, fruit or vegetable 10 may be a root vegetable (e.g., potato, carrot, beet, turnip), a pome (e.g., apple, pear, quince, loquat), or a combination of fruits and/or vegetables. Other firm and crisp fruits and vegetables that may benefit from treatment with an additive include, but are not limited to, cucumbers, melons and squash. In some examples, fruit or vegetable 10 is a firm and crisp fruit or vegetable in that the fruit or vegetable can be cut, such as by shredding, or otherwise processed without disintegrating before and/or after cooking. In some examples, fruit or vegetable 10 is firm and crisp fruit or vegetable in that the fruit or vegetable is freshly harvested. The firmness of a fruit or vegetable can be analyzed using a commercially available texture press, such as those available from Instron, Texture Technologies, or other similar providers.

Normally, the firm and crisp fruits and vegetables 10 used in the present application include pores 12. Pores 12 are channels, cavities, or passages that extend from an exterior surface of such fruit or vegetable 10 toward the interior of the fruit or vegetable 10. Pores 12 allow ingress and egress of flowable liquids and gases to the fruit or vegetable 10.

During processing, such fruits or vegetables 10 may be cooked to prepare the fruit or vegetable for consumption. For example, the fruit or vegetable 10 may be cooked in an oven, boiled in a kettle, or otherwise heated at an elevated temperature to cook the fruit or vegetable. This cooking process may begin to break down the cellular structure of fruit or vegetable 10 and, depending on the type of fruit or vegetable, convert complex carbohydrates to simple sugars. Firm and crisp fruits and vegetables 10 can lose their firmness as compared to an uncooked fruit or vegetable during this cooking process. This loss of firmness can make the fruit or vegetable 10 difficult to cut or further process.

In accordance with this disclosure, the firm and crisp fruit or vegetable 10 is at least partially infiltrated with an additive that functions to help retain the firmness of the fruit or vegetable 10 during and/or after cooking. In some examples, the additive includes a gluconate salt, a lactate salt, or a combination of a gluconate salt and a lactate salt. By infiltrating the firm and crisp fruit or vegetable 10 with the additive, such a fruit or vegetable 10 can maintain sufficient firmness so that the fruit or vegetable 10 can be cut or otherwise processed. In various embodiments, the infiltration of the firm and crisp fruit or vegetable with additive may be done during or prior to the cooking process.

Each fruit or vegetable 10 of the present invention includes an additive that functions to help retain the firmness of the fruit or vegetable 10 upon cooking. In some examples, the firm and crisp fruit or vegetable 10 includes a plurality of additives (e.g., two, three, four, or more additives) that each individually, or together in combination, function to help retain the firmness of such a fruit or vegetable 10 upon cooking.

In one example, the additive includes (or, optionally, consists essentially of) a gluconate salt. The gluconate salt may be an alkali metal gluconate or an alkaline earth metal gluconate. An example alkaline earth metal gluconate is calcium gluconate. In another example, the additive includes (or, optionally, consists essentially of) a lactate salt. The lactate salt may be an alkali metal lactate or an alkaline earth metal lactate. An example alkaline earth metal lactate is calcium lactate. In still another example, the additive includes (or, optionally, consists essentially of) both a gluconate salt and a lactate salt, such as calcium gluconate and calcium lactate. Other additives that may be used with the fruits and vegetables include calcium sulfate and calcium carbonate. While any suitable gluconate and/or lactate salts may be used, calcium gluconate and calcium lactate generally do not affect the taste of the fruit or vegetable 10. This may be beneficial for modifying the firmness properties of the fruit or vegetable 10 without changing the taste profile of the fruit or vegetable.

Any suitable technique can be used to at least partially infiltrate the firm and crisp fruit or vegetable 10 with an additive. In some examples, the fruit or vegetable 10 is at least partially infiltrated with the additive by soaking fruit or vegetable 10 in a liquid solution that includes the additive. For instance, in one example, fruit or vegetable 10 (e.g., a pome or root vegetable) is completely submerged in a water solution that includes the additive. The water solution may enter pores 12 of the pome or root vegetable 10 and flow toward the interior of fruit or vegetable 10. In this manner, fruit or vegetable 10 may be at least partially infiltrated with an additive solution. Depending on a variety of factors, such as the type of additive solution, the type of infiltration process, and the length of time that fruit or vegetable 10 is infiltrated with additive, fruit or vegetable 10 may become partially or even completely saturated with additive solution. Accordingly, in some examples, the additive may only partially infiltrate the fruit or vegetable 10 so that the additive is not transported to or present at the center of the fruit or vegetable, while in other examples, the additive may fully infiltrate the fruit or vegetable so that the additive is transported to and present throughout the entire structure of the fruit or vegetable.

The firm and crisp fruit or vegetable 10 can be infiltrated with additive solutions that have a variety of different concentrations. In one example, the fruit or vegetable 10 is infiltrated with an additive solution that includes (or, optionally, consists essentially of) between 0.01 wt % and 60 wt % additive such as, e.g., between 0.01 wt % and 40 wt % additive, between 0.05 wt % and 25 wt % additive, or between 0.5 wt % and 8 wt % additive. In one specific example, the root vegetable 10 is infiltrated with an additive solution that includes approximately 5 wt % additive. The remaining weight portion of each of the foregoing additive solutions may be made up of water (i.e., to achieve a total balance of 100 wt %). For instance, in the example of an additive solution that includes approximately 5 wt % additive, the solution may further include approximately 95 wt % water. It should be appreciated that the wt % additive may be the weight of a single additive or the combined weight of a plurality of different additives.

In examples where an additive solution includes multiple different additives, the relative weight percentages of each different additive may vary based, e.g., on the type of fruit or vegetable being infiltrated and the types of additives used. For instance, in examples where the additive solution includes (or, optionally, consists essentially of) a gluconate salt and a lactate salt, the additive solution may include between 0.1 wt % and 99.9 wt % gluconate salt and between 99.9 wt % and 0.1 wt % lactate salt, where the weight percentages are based on the total weight of additives in the solution (e.g., the sum of the gluconate salt weight and the lactate salt weight in examples where there are only two additives in the solution).

In some additional examples where the additive solution includes (or, optionally, consists essentially of) a gluconate salt and a lactate salt, the additive solution may include between 25 wt % and 75 wt % gluconate salt and between 25 wt % and 75 wt % lactate salt such as, e.g., between 40 wt % and 60 wt % gluconate salt and between 40 wt % and 60 wt % lactate salt, where the weight percentages are based on the total weight of additives in the solution.

In one example, the additive solution includes (or, optionally, consists essentially of) approximately 50 wt % of a gluconate salt and approximately 50 wt % of a lactate salt, where the weight percentages are based on the total weight of additives in the solution. The foregoing descriptions of additives and additive solutions are merely examples, however, and it should be appreciated that the disclosure is not limited in this respect.

In examples where fruit or vegetable 10 is infiltrated by submerging or otherwise contacting the fruit or vegetable with a water-based additive solution, a suitable amount of additive solution should be put in contact with the fruit or vegetable. The amount of additive solution that is put in contact with the fruit or vegetable may be based on the weight of the fruit or vegetable. In one example, at least one weight part additive solution is added to a container for every weight part of the firm and crisp fruit or vegetable added to the container. In another example, approximately two weight parts additive solution are added to a container for every weight part of fruit or vegetable (e.g. pome or root vegetable) added to the container. Different relative amounts of additive solution and fruit/vegetable are both possible and contemplated.

In examples where the firm and crisp fruit or vegetable 10 is infiltrated by submerging the fruit or vegetable in an additive solution, the fruit or vegetable can be submerged for different amounts of time. In general, submerging the fruit or vegetable 10 in the additive solution for a longer period of time will increase the saturation of the fruit or vegetable 10 and, hence, the total amount of additive transferred to the fruit or vegetable 10 from the solution (i.e., as compared to submerging the fruit or vegetable for a comparatively shorter period of time). In different examples, firm and crisp fruit and vegetable 10 may be submerged in an additive solution between approximately 1 second and approximately 10 minutes such as, e.g., between approximately 30 seconds and approximately 5 minutes. In one example, the firm and crisp fruit or vegetable 10 is submerged in an additive solution for approximately 1 minute.

Firm and crisp fruits or vegetables 10 (e.g. pomes or root vegetables) may be partially processed prior to being infiltrated with the additive solution. Processing prior to infiltration may increase the surface area of the fruit or vegetable 10 and/or remove barriers that limit infusion. For instance, when the fruit or vegetable 10 is an apple, pear, potato, carrot, or similar firm and crisp fruit or vegetable, the skin of the fruit or vegetable can inhibit transport of additive solution into the flesh of the vegetable. For this reason, the fruit or vegetable 10 is peeled in some examples prior to being infiltrated with additive solution. In some additional examples, the fruit or vegetable 10 is cut (e.g., diced, shredded, chopped, or the like) to increase the surface area of the fruit or vegetable exposed to additive solution. Increased surface area can increase the amount of additive solution that enters the fruit or vegetable and/or decrease the amount of time that the fruit or vegetable needs to be exposed to the additive solution. Additional or different pre-infiltration processing steps are possible.

In some examples, the firm and crisp fruit or vegetable 10 is cooked (e.g., heated) while being infiltrated with an additive solution. For example, the pome or root vegetable 10 may be heated to a temperature greater than approximately 98° C. while submerged in an additive solution. Heating the additive solution can cook the fruit or vegetable 10 (e.g., partially or fully) and/or increase the diffusion of the additive solution into the pores of the fruit or vegetable. In some examples, the fruit or vegetable 10 is cooked prior to being infiltrated with additive solution. In various examples, the firm and crisp fruit or vegetable 10 is partially cooked to open pores 12 of the fruit or vegetable 10. Thereafter, the fruit or vegetable 10 may be infiltrated with an additive solution and then further cooked to complete the cooking process. In still other examples, an uncooked fruit or vegetable 10 (e.g., pome or root vegetable) is placed in an additive solution that remains at a substantially ambient temperature.

In some examples, the firm and crisp fruit or vegetable 10 is cooled after being at least partially infiltrated with additive solution. For instance, the fruit or vegetable 10 may be cooled subsequent to being at least partially infiltrated with additive solution but prior to being further processed. The firmness of the fruit or vegetable 10 may increase as the temperature of the fruit or vegetable is reduced from a comparatively higher temperature to a comparatively lower temperature. This may make the fruit or vegetable easier to cut or otherwise process. In examples where the firm and crisp fruit or vegetable 10 is cooled prior to being cut or otherwise processed, the fruit or vegetable may be cooled to a temperature less than 1° C. This may be accomplished by refrigerating the fruit or vegetable 10 for approximately 24 hours, although other techniques and chilling durations are possible.

As noted above, treating fruit or vegetable 10 with an additive in accordance with this disclosure can help the firm and crisp fruit or vegetable retain its firmness during and/or after cooking. In some examples, a fruit/vegetable treated with an additive solution according to the disclosure and then boiled in water for at least 5 minutes exhibits a firmness that is substantially the same as the firmness the fruit/vegetable exhibits prior to being boiled. In other examples, a fruit/vegetable treated with an additive solution according to the disclosure exhibits a firmness after being boiled in water for at least 5 minutes that is at least 20% of the firmness that the root vegetable exhibits prior to being boiled such as, e.g., at least 50%, at least 67.5%, at least 75%, or at least 85% of the firmness that the fruit/vegetable exhibits prior to being boiled.

When fruit or vegetable 10 is at least partially infiltrated with an additive according to the disclosure, the firm and crisp fruit or vegetable may be firmer during and/or after cooking than a comparable fruit or vegetable that is not at least partially infiltrated with an additive. This may make the fruit or vegetable easier to process after cooking. For instance, in some examples, a pome or root vegetable is at least partially infiltrated with an additive solution before, during, or after a cooking process. The pome or root vegetable is then chilled to increase the firmness of the pome or root vegetable. After being suitably chilled, the pome or root vegetable 10 is cut (e.g., diced, shredded, chopped, or the like) to produce a precut fruit or vegetable desired by many consumers. In some examples, pome or root vegetable 10 is further cooked after being cut to make the pome/root vegetable easier to prepare by an end consumer. In these examples, the initial cooking step may partially cook the fruit or vegetable, while the subsequent cooking step may either fully cook the fruit or vegetable or further partially cook the fruit or vegetable.

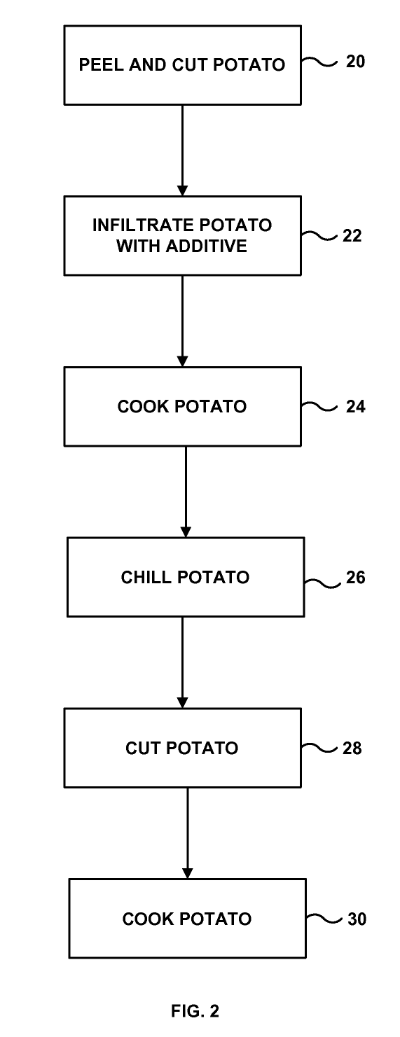

A variety of different techniques may be used to process a firm and crisp fruit or vegetable according to the present disclosure. FIG. 2 is a flow diagram illustrating an example technique for processing a firm and crisp fruit or vegetable, such as a pome or root vegetable, in a manner that helps the fruit or vegetable retain its firmness during and/or after cooking. For ease of description, the technique of FIG. 2 is described with regard to a root vegetable 10 that is a potato. However, different types of firm and crisp fruits and vegetables may be used according to the disclosure, and it should be appreciated that the disclosure is not limited in this respect.

According to the example technique of FIG. 2, potato 10 is peeled and optionally cut (20). Peeling removes the skin of the potato 10, which can act as a barrier that limits the transport of additive solution into the flesh of the potato. Cutting potato 10 increases the surface area of the potato, which can increase the amount of additive solution that enters the potato and/or decrease the amount of time that the potato needs to be exposed to the additive solution.

After peeling and optionally cutting potato 10 (20), potato 10 is at least partially infiltrated with an additive that functions to help retain the firmness of potato 10 upon cooking. In some examples, potato 10 is fully infiltrated (e.g., saturated) with the additive. In some examples, potato 10 is infiltrated by submerging the potato in a water-based solution that includes the additive.

The additive includes one or more additives that function to help retain the firmness of potato 10 upon cooking. In one example, that additive is calcium lactate. In another example, the additive is calcium gluconate. In still another example, the additive includes approximately 50 wt % of calcium gluconate and approximately 50 wt % calcium lactate, where the weight percentages are based on the total weight of additives in the solution.

The technique of FIG. 2 includes partially cooking the potato 10 (24), and, later, completing the cooking of the potato (10) (30). In different examples, potato 10 is cooked before being infiltrated with the additive (22), after being infiltrated with the additive (22), or while being infiltrated with the additive (22). For instance, potato 10 may be cooked while being infiltrated with the additive by submerging potato 10 in a heated (e.g., boiling) solution that includes the additive. In some examples, potato 10 is partially cooked (24). In other examples, the potato 10 is fully cooked.

After partial cooking (24), potato 10 is chilled (26) in the example technique of FIG. 2. For example, potato 10 may be placed in a standard refrigerator for at least 12 hours to chill the potato. Chilling potato 10 may increase the firmness of potato 10 as compared to when potato 10 is at a higher temperature. This may make potato 10 easier to continue processing.

The technique of FIG. 2 includes cutting potato 10 (28). Potato 10 may be cut into any suitable size and shape. In some examples, potato 10 is cut before infiltrating the potato with additive (20), and further cut (e.g., into smaller pieces) after cooking (28). In different examples, potato 10 may be diced, shredded, chopped, or the like. In accordance with some examples, an additive according to the disclosure may increase the firmness of potato 10 as compared to an untreated potato so that the potato can be cut without smashing the potato. For instance, the potato may be cut so that the potato exhibits substantially well-defined edges, where the edges are generally not broken or rounded, as may be exhibited by cutting a less firm potato.

In some examples, as seen in the example technique of FIG. 2, potato 10 is further cooked (30) after being cut (28). Further cooking of potato 10 (30) may fully cook the potato or may further partially cook the potato. In some examples, potato 10 is further cooked (30) using a different cooking technique than the cooking technique initially used to cook the potato (24). For example, potato 10 may initially be boiled and later, after cutting, baked. In other examples, potato 10 is further cooked (30) using the same cooking technique that is used to initially cook the potato (24).

Various examples have been described. These and other examples are within the scope of the following claims.

1. A food product comprising:
a firm and crisp fruit or vegetable at least partially infiltrated with an additive that functions to help retain the firmness of the fruit or vegetable upon cooking, wherein the additive includes a gluconate salt, a lactate salt, or a combination of the gluconate salt and the lactate salt.

2. The food product of claim 1, wherein the gluconate salt is an alkaline earth metal gluconate, and the lactate salt is an alkaline earth metal lactate.

3. The food product of claim 1, wherein the gluconate salt is calcium gluconate, and the lactate salt is calcium lactate.

4. The food product of claim 1, wherein the additive is calcium gluconate.

5. The food product of claim 1, wherein the additive is calcium lactate.

6. The food product of claim 1, wherein the firm and crisp fruit or vegetable is a pome or a root vegetable.

7. The food product of claim 6, wherein the root vegetable is a potato.

8. The food product of claim 7, wherein the potato is a peeled potato.

9. The food product of claim 8, wherein the peeled potato is cut into pieces.

10. The food product of claim 1, wherein the firm and crisp fruit or vegetable is at least partially saturated with the additive.

11. The food product of claim 10, wherein the firm and crisp fruit or vegetable is fully saturated with the additive.

12. The food product of claim 1, wherein the firm and crisp fruit or vegetable is cooked.

13. The food product of claim 1, wherein the firm and crisp fruit or vegetable is a potato and the additive is at least one of calcium gluconate and calcium lactate.

14. The food product of claim 1, wherein the additive includes between 0.1 wt % and 99.9 wt % of the gluconate salt and between 99.9 wt % and 0.1 wt % of the lactate salt.

15. A method comprising:
placing a firm and crisp fruit or vegetable in a water solution that includes at least one additive that functions to help retain the firmness of the fruit or vegetable upon cooking, wherein the additive includes a gluconate salt, a lactate salt, or a combination of the gluconate salt and the lactate salt.

16. The method of claim 15, wherein the gluconate salt is an alkaline earth metal gluconate, and the lactate salt is an alkaline earth metal lactate.

17. The method of claim 15, wherein the at least one additive is calcium gluconate.

18. The method of claim 15, wherein the at least one additive is calcium lactate.

19. The method of claim 15, wherein the water solution includes between 0.01 wt % and 60 wt % additive.

20. The method of claim 19, wherein the water solution includes between 0.5 wt % and 25 wt % additive.

21. The method of claim 15, wherein placing the firm and crisp fruit or vegetable in the water solution comprises placing less than approximately 1 weight part of the firm and crisp fruit or vegetable for every 1 weight part of water solution.

22. The method of claim 15, further comprising cooking the firm and crisp fruit or vegetable.

23. The method of claim 15, further comprising removing the firm and crisp fruit or vegetable from the water solution between 1 second and 10 minutes after placing the firm and crisp fruit or vegetable in the water solution.

24. The method of claim 15, wherein the firm and crisp fruit or vegetable is selected from the group consisting of a potato, a carrot, a beet, a turnip, an apple, a pear, a quince and a loquat.

25. The method of claim 15, wherein the firm and crisp fruit or vegetable is a potato and the additive is at least one of calcium gluconate and calcium lactate.
